(19) United States
(12) Patent Application Publication
(10) Pub. No.: US 2017/0359876 A1
(43) Pub. Date: Dec. 14, 2017

(54) CURRENT TUNEBACK IN LIGHT EMITTING DIODE LUMINAIRES

(71) Applicant: Cooper Technologies Company, Houston, TX (US)

(72) Inventors: Hui Zhang, Manlius, NY (US); Joseph Michael Manahan, Manlius, NY (US)

(21) Appl. No.: 15/618,966

(22) Filed: Jun. 9, 2017

Related U.S. Application Data
(60) Provisional application No. 62/348,389, filed on Jun. 10, 2016.

(51) Int. Cl. H05B 33/08; H05B 37/02

(52) U.S. Cl. CPC H05B 33/0854; H05B 37/0272

(57) ABSTRACT

Safety improvements to Light Emitting Diodes (LED) are discussed herein. As the LEDs that are part of a luminaire heat up and cool down, the current supplied will be tuned to improve the safety of the luminaire to manage the levels of light and heat produced. At least one thermally active electrical component is incorporated into the LED load of the luminaire, which is communicated to an LED current control to signal when to adjust current levels providing by a driving circuit. Current is reduced when the temperature of the LED load exceeds a threshold, and or returned to an optimal current when the temperature no longer exceeds the threshold.

### TECHNICAL FIELD

The present disclosure generally relates to Light Emitting Diode (LED) luminares and, more particularly, improving their safety of use.

### BACKGROUND

A Light Emitting Diode (LED) is an electrical component that emits light when a suitable voltage is applied across its leads. Luminares may include one or more LEDs in a form factor suitable for various applications. For example, a luminaire may be shaped like an incandescent lightbulb or fluorescent filament to fit the lamps and light fixtures in a home or office. Luminares may also be designed for use in industrial environments, where caustic chemicals, flammable materials, extreme temperatures, or combinations thereof may be present at a greater frequency than in the home or office. Several industrial standards are in place to ensure that the luminaire does not become a danger in various environments (e.g., provide reactants to caustics, become a flashpoint around flammable materials, warp under temperature). These standards often require pass/fail testing when the tested device is initially constructed, but inherent failure modes of some LED devices may result in an unanticipated risks, which may lead to safety related events such as fire and explosion during or after installation.

### SUMMARY

The present disclosure is directed to systems, devices, and methods for improving the safety of Light Emitting Diode (LED) luminares through active tuning of the drive current to the LED. By measuring the heat of an LED load with a thermally active electrical component, a current controller may adjust the current running through the components of the LED load, and thereby reduce the heat produced via resistive losses when heat is building up, and allow the LED load to cool to acceptable levels.

The above summary is not intended to describe each aspect or every implementation. A more complete understanding will become apparent and appreciated by referring to the detailed description in conjunction with the accompanying drawings, and that the scope of the present disclosure is set by the claims.

### BRIEF DESCRIPTION OF THE DRAWINGS

The accompanying drawings, which are incorporated in and constitute a part of this disclosure, illustrate various aspects of the present disclosure. The drawings are not necessarily to scale. Like numbers used in the drawings refer to like components, however, it will be understood that the use of a number to refer to a component in a given drawing is not intended to limit the component in anther drawing labeled with the same number. In the drawings:

FIG. 1A illustrates an example LED luminaire;

FIG. 1B is a circuit diagram for an example tuneback circuit for an LED luminaire; and

FIG. 2 is a flow chart showing general stages involved in a method for implementing current tuneback in an LED luminaire.

### DETAILED DESCRIPTION

Various examples will be described in detail with reference to the drawings, wherein like reference numerals represent like parts and assemblies throughout the several views. Any examples set forth in this disclosure are not intended to be limiting and merely set forth some of the many possible ways for implementing the broad inventive aspects disclosed herein.

A Light Emitting Diode (LED) is an electrical component that converts the energy supplied in electrical current into light via electroluminescence. As will be appreciated, as current runs through (non-superconductive) electrical components, such as LEDs, a portion of the energy in the current is converted to heat via the component's resistance. This heat is radiated to the surrounding components and environment, and may build up in the component, making it hotter, if the energy supplied to the component produces more resistive heat than the component can dissipate in a given period of time. To keep a component within a specified temperature range, heatsinks, fans, cooling ducts, and the like can improve the ability of a component to dissipate heat to the environment, or the current running through a component may be reduced to thereby reduce the heat needed to be dissipated. As will be appreciated, keeping a component or fixture within a given temperature range may improve the safety of the electrical device (e.g., reducing the likelihood that the device may act as an ignition source), the longevity of the components of the fixture (e.g., reducing the likelihood of burning a component out), and help devices meet industrial standards for use in a greater variety of settings (e.g., a luminaire deemed safe for use in a home environment may not meet safety standard for use in a coal mine without additional heat controls). Moreover, depending on the failure mechanism of the luminaire, when a subset of the device (e.g., a die in a multi-die device) fails, current from the failed portions may be driven through the portions that have not yet failed, which can increase the overall heat in the device (or the operable portions thereof) and can lead to accelerated failure of the portions and/or safety hazards.

To adapt a luminaire to a hazardous environment, the LEDs may be isolated from the environment by an air-tight casing including a non-reactive material (e.g., silicone or glass) through which the LEDs will shine. The casing may be clear or colored, and may be impact resistant or made of a shatter proof material. Additional heatsinks, arc suppression, and interlock features may also be included so that when the luminaire is active in a hazardous environment, no ignition or reaction sources will be exposed to the environment.

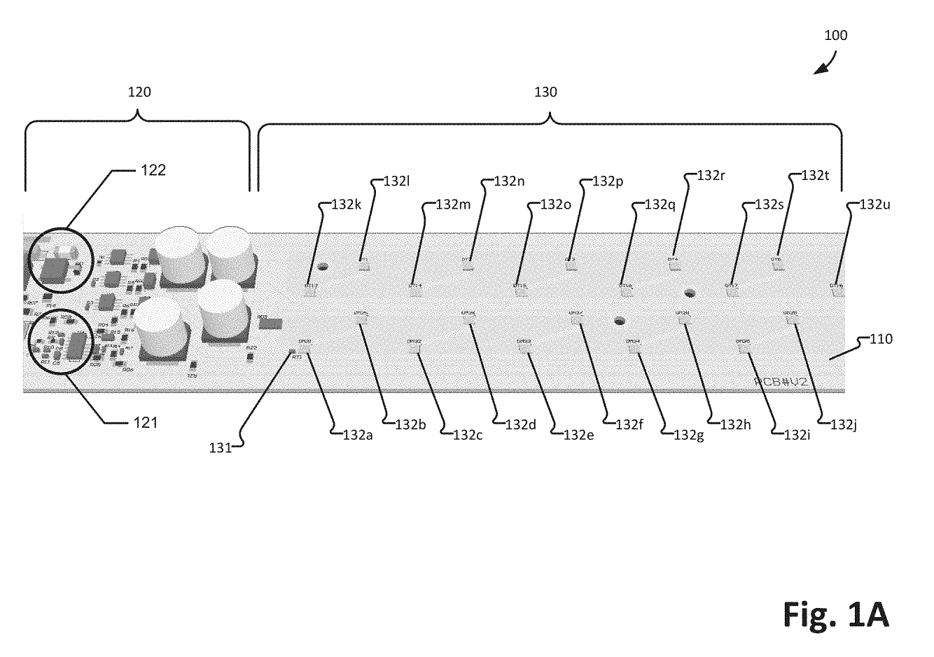

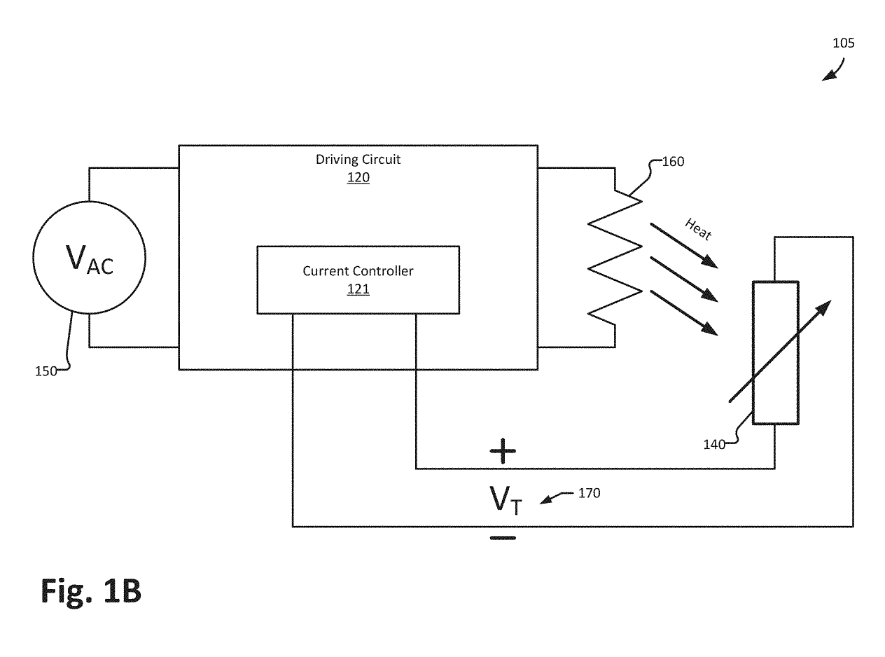

FIG. 1A illustrates an example LED luminaire 100. In the example LED luminaire, several components are disposed of on a Printed Circuit Board (PCB) 110, although one of ordinary skill in the art will appreciate that the components shown may be communicated together without the PCB 110 (e.g., on a breadboard, via direct wiring), and that more or fewer components than illustrated in FIG. 1 may comprise an LED luminaire 100, and that different arrangements of components than shown in FIG. 1 are possible. The example LED luminaire 100 is provided as a non-limiting example.

The example LED luminaire 100 is illustrated in two sections; the driving circuit 120, including a current controller 121 and a rectifier 122, and the LED load 130, including a temperature sensor 131 and LEDs 132a-u (generally, LEDs 132). Although both sections are illustrated as being disposed of on the same PCB 110, one of ordinary skill in the art will recognize that the driving circuit 120 and LED load 130 may be disposed of on separate PCBs 110, and that a single driving circuit 120 may be communicated to several LED loads 130.

The driving circuit 120 includes a current controller 121 and a rectifier 122. The current controller 121 controls the level of current provided from an alternating current power source (not illustrated), and the rectifier 122 converts alternating current into direct current for use by the LED load 130. In aspects that use a direct current power source (e.g., a battery) instead of an alternating current power source, the current controller 121 controls the level of current provided from the direct current power source and the rectifier 122 may be omitted or bypassed. In various aspects, the rectifier 122 may be of various configurations and contain components of various values depending on the design specifications and use cases expected of the example LED luminaire 100, and one of ordinary skill in the art will be familiar with the construction of a rectifier 122 to meet the needs of a given LED luminaire 100.

In various aspects, the current controller 121 includes a microprocessor that processes signals according to stored instructions (e.g., burned into the microprocessor, stored as Electrically Erasable Programmable Read-Only Memory (EEPROM)) to affect a level of current provided to the LED load 130. In other aspects, the current controller 121 includes a series of logic gates that control switches that will open and close in response to signals received from the LED load 130 to raise or lower current levels transmitted to the LED load 130. Changes to the level of current provided to the LED load 130 may be accomplished with a dimming functionality, allowing the LED load 130 to produce less light with less current, or with a switching functionality, temporarily cutting off current to an LED load 130 or a portion of the LEDs 132 in an LED load 130. For example, the current controller 121 may temporarily restrict the flow of current to the LEDs 132 (turning them off when current reaches zero or a cutoff for LED operation) until the heat of the LED load 130 drops below a threshold. In another example, a first LED load 130 has its current set to zero until the first LED load 130 cools below a threshold temperature, but a second LED load 130 is provided current. The thresholds may be set via various standards bodies according to various standards (e.g., Underwriters Laboratories (UL), the Institute for Electrical and Electronic Engineers (IEEE), European Conformity (CE), China Compulsory Certificate, (CCC)) for the temperature of the luminaire in-use, which one of ordinary skill in the art will be able to apply.

The LED load 130 includes at least one temperature sensor 131 and at least one LED 132. The temperature sensor 131 is communicated with the current controller 121 so that the temperature of the LED load 130 can be reduced via the regulation of current transmitted to the LED load 130.

In various aspects, the temperature sensor 131 is a thermistor, a thermocouple, a resistance temperature detector (RTD), or an infrared (IR) photodiode. In some aspects, where the resistance of the temperature sensor 131 changes in relationship with temperature, a reference current of a value known to the current controller 121 is fed through the temperature sensor 131 so that the current controller 121 can measure a change in resistance (via changes in voltage across the temperature sensor 131) that indicates a temperature of the LED load 130. In some aspects, the reference current supplied to the temperature sensor 131 may be the operating current of the LEDs 132 that the current controller 121 adjusts to affect the temperature of the LED load 130, while in other aspects a separate current is provided so that if the operating current is modified (or set to zero) the reference current will remain constant.

In aspects where more than one temperature sensor 131 is provided, multiple temperature sensors 131 may be associated with the same LED load 130 or with multiple LED loads 130. The current controller 121 may average the readings from the multiple temperature sensors 131 or use the maximum value received from a temperature sensor 131 when the multiple temperature sensors 131 are on one LED load 130, but will treat the readings from multiple temperature sensors 131 from multiple LED loads 130 separately to manage the heat of each LED load 130 separately. Readings may be averaged by using a shared lead of a microprocessor in communication with multiple analog temperature sensors 131 wired in parallel, a bitwise averaging circuit (e.g., an Adder and a bit-shift register) when using digital temperature sensors 131, or by other means known to those of ordinary skill in the art. Additionally or alternatively, another algorithm besides averaging may be used to collect and smooth cumulative readings over a period of time. Contrarily, readings may be separated by using different leads of a microprocessor (or separate sets of logic gates) to receiving readings.

FIG. 1B is a circuit diagram 105 for an example tuneback circuit for use in an LED luminaire 100. As illustrated, a resistor 160, representing the resistance of the LED load 130 of at least one LED 132, and a thermistor 140, representing a temperature sensor 131 that has different resistances at different temperatures, are in thermal communication with one another. As current flows through the resistor 160, the thermistor 140 may begin to heat up in response, and its resistance will change. The current controller 121 measures the voltage V_{T} 170 across the thermistor 140 to track the change in resistance corresponding to changes in its temperature. For example, by applying a constant current to the thermistor 140 and comparing V_{T} 170 to a base or a threshold value, the current controller 121 can determine when the thermistor 140 has reached a given resistance (and therefore a given temperature) indicating that the LED load 130 will have similarly reached or exceeded a given temperature threshold. Once the current controller 121 has determined that the LED load 130 has reached or exceeded a temperature threshold via the corresponding changes to V_{T} 170, the driving circuit 120 will be signaled to adjust the current provided to the LED load 130 to ensure the proper and safe continued operation of the LED luminaire 100.

In some aspects, when an overheat threshold is reached, some or all of the LEDs 132 comprising the LED load 130 may be switched off, the current from the AC power source 150 may be reduced, a secondary string of LEDs 132 may be activated instead of a primary string of LEDs 132, a cooling apparatus (e.g., a fan, a vent, a heat pump) may be provided power, etc. In other aspects, when a cooldown threshold is reached, such as when the actions taken in response to an overheat threshold are deemed effective and the LED luminaire 100 can safely resume normal operations, some or all of the LEDs 132 comprising the LED load 130 may be switched on, a primary string of LEDs 132 may be activated instead of a secondary string of LEDs 132, the current provided from the power source 150 may be increased (up to a nominal value), a cooling apparatus may be turned off, etc.

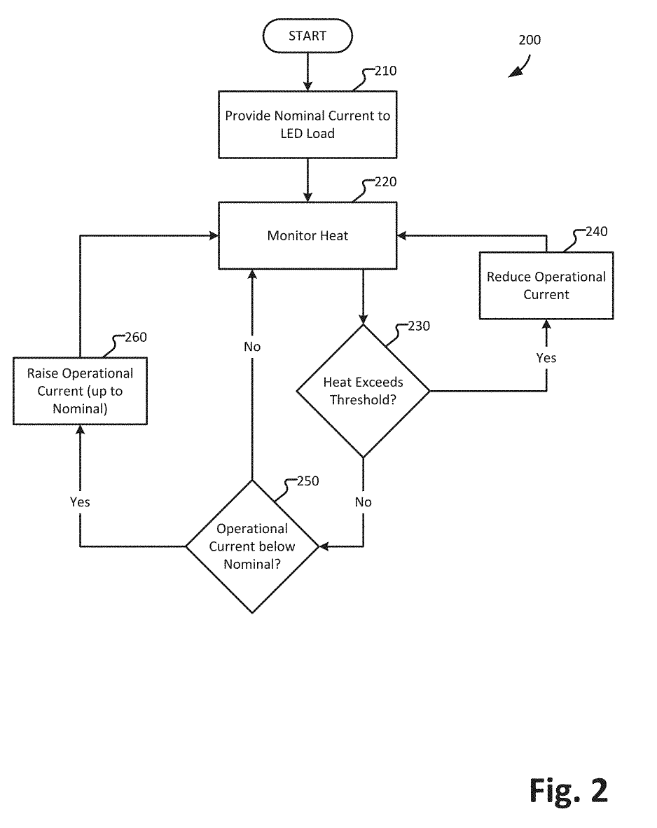

FIG. 2 is a flow chart showing general stages involved in a method 200 for implementing current tuneback in an LED luminaire 100. Method 200 begins at OPERATION 210, where a nominal current is provided to the LED load 130 of an LED luminaire 100 when a power source is applied (e.g., a user flips a light switch associated with the LED luminaire 100). The nominal current is the current that the LED luminaire 100 is designed to provide to the LED load 130 to produce the requested amount to light from the LEDs 132. For example, an LED luminaire 100 may be designed to provide 100% of rated light when 50 mA are provided to the LED load 130, and when a user selects a dimmer function of the LED luminaire 100 for 50% of rated light, 25 mA are provided to the LED load 130. In the preceding example, the currents of 50 mA and 25 mA are both nominal currents for 100% light rating and 50% light rating respectively, although one of ordinary skill in the art will recognize that the numbers in the above example have been simplified to clearly present the concept of a nominal current.

Method 200 proceeds to OPERATION 220, where heat is monitored. Depending on the number and arrangement of temperature sensors 131, the current controller 121 may measure an average, a maximum, or several temperature readings from the LED load 130. In various aspects, the temperature readings may be polled from the sensors or received in real-time. To prevent spikes in readings, in various aspects the multiple readings from one temperature sensor 131 (or group of related temperature sensors 131) may be averaged over a time period or another algorithm may be applied to adjust the level of current provided to the LED load 130 based on the cumulative temperature data from one or more temperature sensors 131.

These temperature readings are compared to a threshold at DECISION 230 to determine whether the temperature exceeds the threshold. When the reading exceeds a threshold, method 200 proceeds to OPERATION 240. When the reading does not exceed the threshold, method 200 proceeds to DECISION 250.

At OPERATION 240, the operational current is reduced by the current controller 121. As will be appreciated, when the current controller 121 reduces the operational current in steps (e.g., 100% to 75% to 50% to 25% to 0%), multiple temperature thresholds may exist so that the current controller 121 may adjust the operational current in accordance with the steps. Steps may be even (n % steps), or uneven, or set to grow/shrink (e.g., 100% to 90% to 70% to 40% to 0%). When the current controller 121 adjusts the operational current in a continuum according to the temperature sensor 131 (e.g., an analog reading from the temperature sensor 131 produces an analog reduction in the operational current) the threshold may be a cutoff value (voltage or current) before which no adjustments to the operational current will be made.

In various aspects, a cutoff value may be supplied by a diode breakdown or avalanche, switches, or the sensitivity of the current controller 121. Method 200 then returns to OPERATION 220 to continue monitoring the heat of the LED load 130.

In aspects where there are multiple temperature sensors 131 associated with different LED loads 130, the current controller 121 may adjust the current supplied to the LED load(s) 130 so that each LED load 130 is affected individually by an associated temperature sensor 131 (e.g., a first temperature sensor 131 or group thereof affects the current supplied to a first LED load 130), is affected mutually by an unassociated temperature sensor 131 (e.g., a second temperature sensor 131 associated with a second LED load 130 may affect the current supplied to a first LED load 130 regardless of what temperature is measured by an associated first temperature sensor 131), or is affected in aggregate by multiple temperature sensors 131 (e.g., an average temperature value of the first LED load 130 and the second LED load 130, as measured by a first temperature sensor 131 and a second temperature sensor 131 respectively, is used to affect the current provided to both LED loads 130). Additionally, when there are multiple LED loads 130, the power supplied to a given LED load 130 may be separately regulated (e.g., the power supplied to first LED load 130 may be different than the power supplied to second LED load 130) or commonly regulated (e.g., the power supplied to first LED load 130 is equal to the power supplied to second LED load 130 when power is supplied to both of the LED loads 130).

At DECISION 250, it is determined whether the operational current is below the nominal current. When the operational current is not below the nominal current, method 200 returns to OPERATION 220 to continue monitoring the heat of the LED load 130 with the present operational current being equal to the nominal current. When the operational current is below the nominal current, method 200 proceeds to OPERATION 260.

In various aspects where the operational current is adjusted in steps, the current controller 121 may set a time threshold between the determination in DECISION 230 and the determination in DECISION 250 so that a temperature fluctuating above and below the temperature threshold does not cause the current controller 121 to introduce flicker into the LED luminaire 100 as the operational current is adjusted upward and downward. A time threshold may be set via a number of clock cycles in a microprocessor between performing the operations, via an averaging of temperatures in a register, or the speed of the components in the current controller 121 (e.g., switching delays).

At OPERATION 260, the operational current is raised. As will be appreciated, the operational current may be raised in steps (e.g., 0% to 25% to 50% to 75% to 100%) or in a continuum similarly to how the operational current is reduced in OPERATION 240, but will not be raised to exceed the nominal current. Method 200 then returns to OPERATION 220 to continue monitoring the heat of the LED load 130.

Method 200 may conclude when the power source is removed, and may start again when the power source is reapplied.

Systems, devices or methods disclosed herein may include one or more of the features structures, methods, or combination thereof described herein. For example, a device or method may be implemented to include one or more of the features and/or processes above. It is intended that such device or method need not include all of the features and/or processes described herein, but may be implemented to include selected features and/or processes that provide useful structures and/or functionality.

Various modifications and additions can be made to the disclosed embodiments discussed above. Accordingly, the scope of the present disclosure should not be limited by the particular embodiments described above, but should be defined only by the claims set forth below and equivalents thereof.

We claim:

1. A light emitting diode (LED) luminaire, comprising:
an LED load, including at least one light emitting diode and at least one temperature sensor;
a driving circuit providing power to the LED load, including a current controller in communication with the at least one temperature sensor for regulating an amount of power provided to the LED load in response to a temperature of the LED load measured by the at least one temperature sensor.

2. The LED luminaire of claim 1, wherein the LED load is mounted on a first printed circuit board and the driving circuit is mounted on a second printed circuit board.

3. The LED luminaire of claim 1, further comprising a second LED load, including at least one second light emitting diode and at least one second temperature sensor, the at least one second temperature sensor in communication with the current controller for regulating a second amount of direct current power provided to the second LED load in response to changes in a second temperature associated with the second LED load.

4. The LED luminaire of claim 3, wherein the amount of power to the LED load is regulated in response to the second temperature; and wherein the second amount of direct current power provided to the second LED load is regulated in response to the temperature of the LED load.

5. The LED luminaire of claim 3, wherein the current controller regulates the power provided to the LED load and the second amount of direct current power provided to the second LED load to be equal.

6. The LED luminaire of claim 1, wherein the LED luminaire is adapted for use in a hazardous environment.

7. The LED luminaire of claim 1, wherein the at least one temperature sensor includes a thermistor.

8. The LED luminaire of claim 1, wherein the at least one temperature sensor includes a thermocouple.

9. The LED luminaire of claim 1, wherein the at least one temperature sensor includes a photodiode operable to receive infrared light.

10. The LED luminaire of claim 1, wherein the at least one temperature sensor includes a resistance temperature detector.

11. A light emitting diode (LED) luminaire, comprising:
a temperature sensor proximate to an LED load, operable to measure a temperature of the LED load;
a current controller disposed remotely from the LED load and in communication with the temperature sensor, operable to adjust a level of current provided to the LED load in response the temperature measured by the temperature sensor.

12. The LED luminaire of claim 11, wherein the temperature sensor is mounted on a printed circuit board on which LEDs comprising the LED load are mounted.

13. The LED luminaire of claim 11 further comprising, a second temperature sensor disposed of on the LED load, operable to measure a second temperature of the LED load.

14. The LED luminaire of claim 13, wherein the current controller uses a higher temperature of the temperature measured by the temperature sensor and the second temperature measured by the second temperature sensor to adjust the level of current provided to the LED load.

15. The LED luminaire of claim 13, wherein the current controller uses an algorithm based on the cumulative temperature data of the temperature measured by the temperature sensor and the second temperature measured by the second temperature sensor to adjust the level of current provided to the LED load.

16. The LED luminaire of claim 11, wherein the LED luminaire is adapted for use in a hazardous environment.

17. The LED luminaire of claim 11, wherein the temperature sensor is a thermistor.

18. A light emitting diode (LED) luminaire, comprising:
at least one LED that is provided an operating current from a power source;
a temperature sensor, provided a reference current from the power source while the at least one LED is provided the operating current; and
a current controller in communication with the power source and the temperature sensor, operable to measure a voltage across the temperature sensor and to reduce the operating current provided from the power source to the at least one LED when the voltage reaches a threshold.

19. The LED luminaire of claim 18, wherein the threshold is set according to an industrial standard for use of luminares in a hazardous environment.

20. The LED luminaire of claim 18, wherein the temperature sensor disposed of between the power source and the at least one LED, wherein the reference current is the operating current.

21. The LED luminaire of claim 20, wherein the temperature sensor is a thermistor.

22. The LED luminaire of claim 18, wherein the reference current is a constant value current.

23. A light emitting diode (LED) luminaire, comprising:
a power source;
at least one LED that is provided an operating current from the power source;
a temperature sensor, having variable resistance at different temperatures and be part of a voltage divider circuit operated from a constant voltage; and
a current controller in communication with the power source and the temperature sensor, operable to measure a voltage across the temperature sensor and to reduce the operating current provided from the power source to the at least one LED when the voltage reaches an overheat threshold.
